(19) United States
(12) Patent Application Publication
(10) Pub. No.: US 2005/0152129 A1
(43) Pub. Date: Jul. 14, 2005

(54) Invisible marking apparatus

(76) Inventor: Donn M. Delson, Agoura Hills, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/757,133

(22) Filed: Jan. 14, 2004

(51) Int. Cl. F21V 33/00

(52) U.S. Cl. 362/96

(57) ABSTRACT

The present invention disclosed and claimed herein, in one aspect thereof, comprises a marking kit including a housing, a marking implement to dispose an invisible mark onto a substrate and an ultraviolet light source disposed in communication with the housing to illuminate the invisible mark on the substrate.

### BACKGROUND OF THE RELATED ART

The present invention relates to marking implements and other marking devices used to protect confidential information. It finds particular application in conjunction with writing and marking systems utilizing invisible marking compositions (e.g. invisible ink) and ultraviolet (UV) detection lighting sources whereby the invisible marking composition becomes visible when exposed to UV light.

Conventionally, UV light sources have been used to illuminate “hidden” confidential information. For example, confidential information has been impregnated onto credit cards and automobile driver's licenses with UV sensitive ink. Accordingly, UV light sources have been used to illuminate this otherwise hidden information in order to validate the authenticity of the confidential information as well as the authenticity of the card itself.

### SUMMARY OF THE DISCLOSED EMBODIMENT(S)

The present invention disclosed and claimed herein, in one aspect thereof, comprises marking kit including a housing, a marking implement to dispose an invisible mark onto a substrate and an ultraviolet light source disposed in communication with the housing to illuminate the invisible mark on the substrate.

In accordance with an embodiment, the invisible mark is created using an ultraviolet-sensitive ink.

In one embodiment, the marking implement includes a barrel or shaft, a well to hold a quantity of an ultraviolet light-sensitive composite wherein the well is disposed within the barrel and a tip or opening disposed on one end of the barrel to permit the discharge of the ultraviolet light-sensitive composite onto a substrate.

In another embodiment, the housing includes a cavity to store the marking implement and a fastening means (e.g. Velcro™) to secure the marking implement to the housing.

In yet another embodiment, the marking kit includes a power source to provide power to illuminate the ultraviolet light source. The power source is an alternating current (AC) or direct current (DC) power source. As well, an AC/DC converter to convert an input power to the ultraviolet light source from AC to DC may be provided.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

For a more complete understanding of the present apparatus and the advantages thereof, reference is now made to the following description taken in conjunction with the accompanying drawings in which:

FIG. 1 illustrates a front perspective view of an apparatus depicting a housing and an attached marking implement in accordance with a disclosed embodiment;

FIG. 2 illustrates a rear perspective view of an apparatus depicting an ultraviolet (UV) light source in accordance with a disclosed embodiment;

FIG. 3 illustrates a front perspective view of an apparatus depicting a housing and marking implement internally contained within a cavity in accordance with a disclosed embodiment;

FIG. 4 illustrates a front perspective view of an apparatus depicting a housing and marking implement external of a cavity in accordance with a disclosed embodiment;

FIG. 5 illustrates a front perspective view of a case in accordance with a disclosed embodiment;

FIG. 6 illustrates a front perspective view of an open case revealing the apparatus contained therein;

FIG. 7 illustrates a cross-sectional view of a combination marking implement and UV light assembly in accordance with a disclosed embodiment; and

FIG. 8 illustrates a cross-sectional view of a combination marking implement and UV light assembly in accordance with a disclosed embodiment.

### DETAILED DESCRIPTION OF THE EMBODIMENT(S)

The following includes examples of various embodiments and/or forms of components that fall within the scope of the present apparatus that may be used for implementation. Of course, the examples are not intended to be limiting and other embodiments may be implemented without departing from the spirit and scope of the invention.

Briefly describing one embodiment of the present apparatus, it provides for a combination of a marking implement and ultraviolet (UV) light source. Specifically, one embodiment is directed toward a marking implement configured to transfer an ultraviolet light-sensitive composite onto a substrate. Additionally, in accordance with one embodiment, an ultraviolet light source is provided to reveal the markings created by the marking implement.

In other words, a marking implement capable of transferring an invisible mark onto a substrate is provided. Further, a UV light source may be used to reveal the hidden messages scribed onto the substrate. It is contemplated that the present apparatus may be used to protect and maintain secrecy in any desired manner. For example, the present apparatus may be used to protect confidential information including but, not limited to, account passwords, personal information, social security numbers, credit card numbers, driver's license numbers, bank account information, safe combinations, trade secrets, phone numbers or the like.

It will be appreciated that, in accordance with an embodiment, the “invisible” mark scribed onto a substrate may be subtly visible at the time of scribing. Thereafter, the mark will become virtually invisible to human vision. For example, a mark may appear slightly yellowish in color when scribed. Upon drying or curing, the pigment may disappear thereby causing the mark to appear invisible. Throughout this disclosure and claims, “invisible” is to mean “impossible or nearly impossible to see; imperceptible by the eye.”

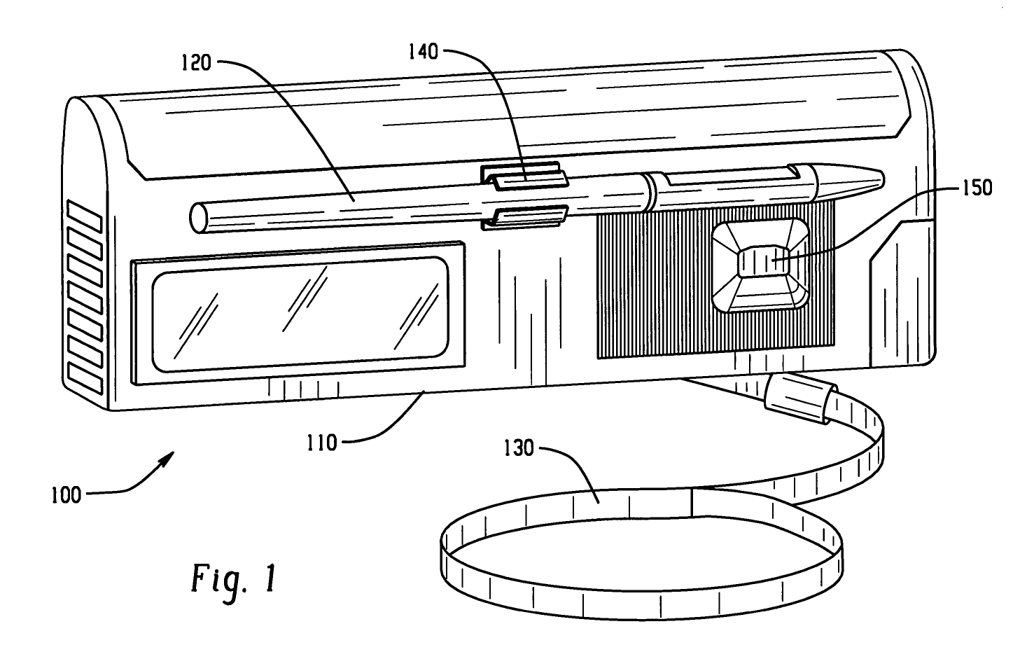

Illustrated in FIG. 1 is a front perspective view of an apparatus 100 depicting a housing 110 and a marking implement 120 in accordance with a disclosed embodiment. The apparatus components shown in FIG. 1 generally represent the apparatus 100 and may have any desired configuration and/or placement without departing from the spirit, scope and/or operation of the present apparatus.

With continued reference to FIG. 1, the apparatus 100 includes the housing 110 containing a UV light source (not shown), the marking implement 120, and an optional carrying handle or strap 130. Additionally, as shown in FIG. 1, the housing 110 may be optionally equipped with a fastening means 140 to fasten the marking implement 120 to the housing 110. Although the fastening means 140 depicted in FIG. 1 is a clamping means, an artisan will appreciate that any fastening means known in the art may be used without departing from the spirit and scope of the present apparatus. For example, alternate fastening means such as Velcro™, tape, pins, male/female connectors, or the like may be used in accordance with alternate embodiments of the present apparatus.

Further, as illustrated in FIG. 1, the apparatus 100 may be equipped with a switching means 150 to control the power to illuminate the UV light source (not shown). Of course, one skilled in the art will appreciate that any switching means known in the art may be used without departing from the spirit and scope of the present apparatus.

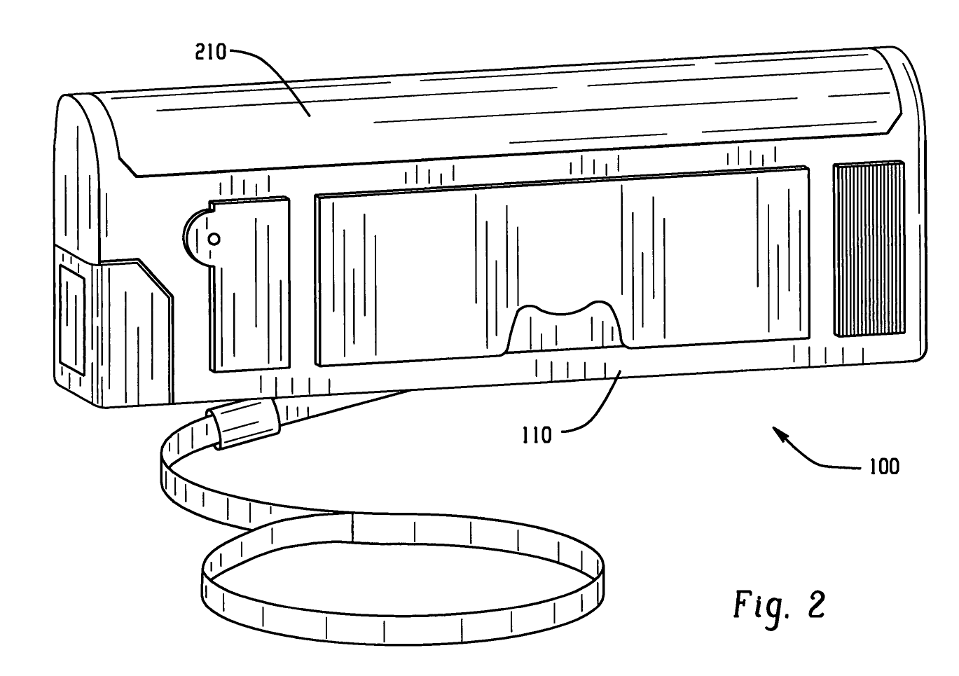

FIG. 2 illustrates a rear perspective view of the apparatus 100 depicting a UV light source 210 in accordance with a disclosed alternate embodiment. As discussed with reference to FIG. 1, the UV light source 210 may be operatively connected to a power source (not shown) via switching means 150 (shown in FIG. 1).

Again with reference to FIG. 1, in operation, a user may remove the marking implement 120 from the fastening means 140 in order to scribe an invisible mark onto a substrate (e.g. paper medium). It will be appreciated that the marking implement 120 as disclosed in FIG. 1 may be any marking means known in the art capable of transferring a UV-sensitive mark onto a substrate. Additionally, it will be appreciated that the housing 110 may include a cavity (not shown) to store a quantity of paper medium (e.g. post-it™ note pad).

In other words, the marking implement 120 may be an ink pen (as shown) configured to transfer a UV-sensitive “invisible-ink” composite onto a substrate or surface (e.g. paper). It will be appreciated that other writing implements known in the art may be used in accordance with the present apparatus without departing from the spirit and scope of the present invention. For example, a wax or crayon-type marking implement constructed of a UV-sensitive composite may be used.

Once an invisible mark is transferred from the marking implement 120 to a substrate, the UV light source 210 (of FIG. 2) may be used to illuminate the secret message. It will be appreciated, that any UV light source may be used to reveal the invisible markings scribed with the marking implement 120.

Continuing with the embodiment, the user may operate the switch means 150 in order to illuminate the UV light source 210. As illustrated in FIG. 1, upon activating switching means 150, power may be transferred from a power source (not shown) to illuminate the UV light source 210. Once illuminated, the UV light source 210, may be suitably configured to react with the UV-sensitive mark in order to reveal the hidden message.

It will be appreciated that the power source (not shown) may included within the housing 110 and be any alternating current (AC) or direct current power source know in the art suitably adapted to illuminate the UV light source 210. Additionally, it will be appreciated that the present apparatus 100 may be suitably configured to operate with either AC or DC power supplied. Moreover, the apparatus may be equipped with an AC/DC power converter in order to convert standard AC power to a suitable DC level in order to illuminate the UV light source 210. An alternate embodiment of the present apparatus 100 may be suitably configured to operate using solar or light power in order to illuminate the light source 210.

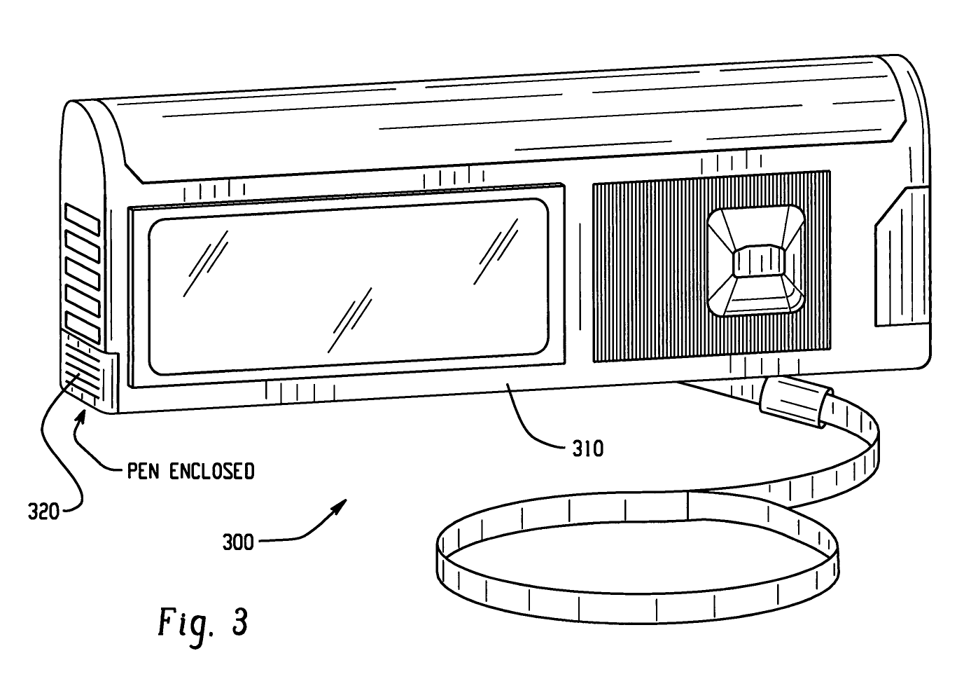

FIG. 3 illustrates an alternate embodiment of the present invention. As illustrated in FIG. 3, an alternate apparatus 300 is shown. Specifically, the apparatus 300 may be configured to include a housing 310 equipped with a cavity to store the marking implement (not shown). As shown in FIG. 3, a lid 320 may be disposed to secure the marking implement (not shown) in the cavity (not shown) of the housing 310.

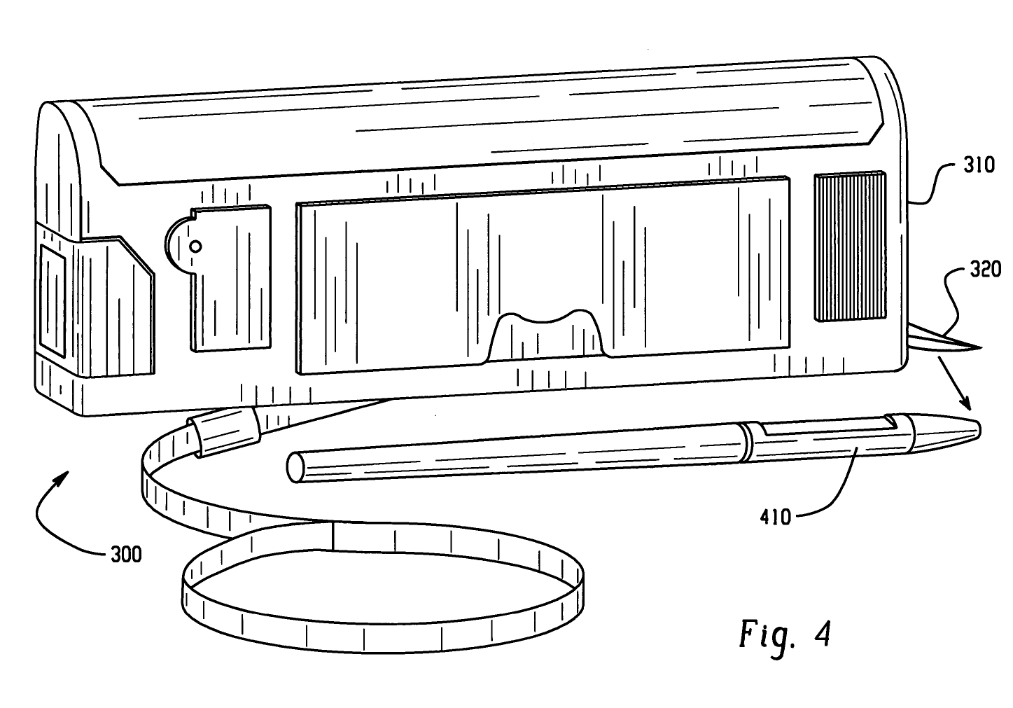

FIG. 4 illustrates a front perspective view of the apparatus 300 depicting the housing 310 and a marking implement 410 external of the internal cavity (not shown) in accordance with a disclosed embodiment. As shown in FIG. 4, the lid 320 is illustrated in an open position in order to permit the marking implement 410 to be removed from the cavity (not shown) internal to the housing 310.

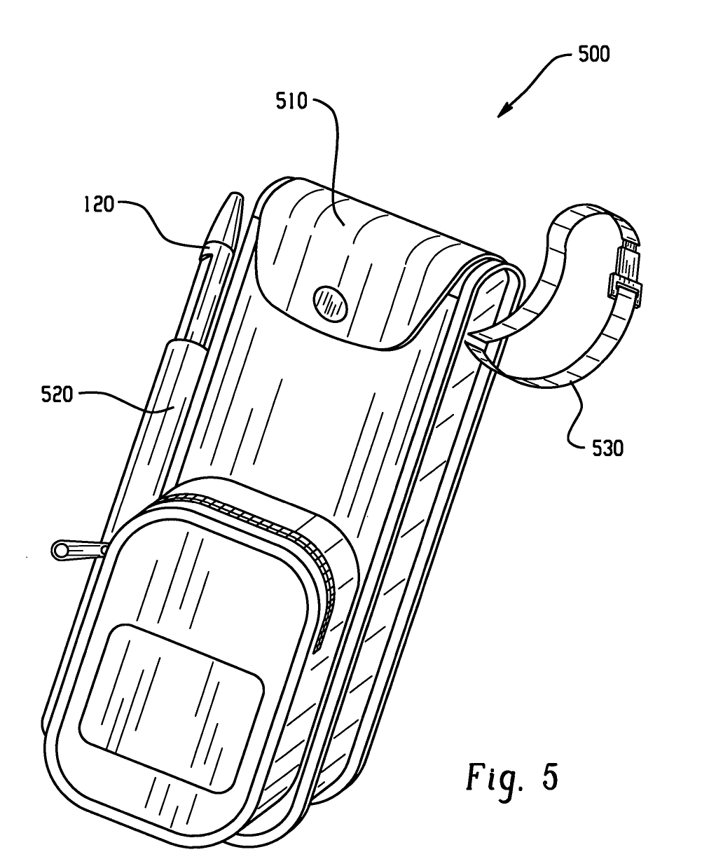

FIG. 5 illustrates a front perspective view of a case 500 in accordance with a disclosed embodiment. The case 500 may be suitably configured to house the apparatus 100 of FIG. 1 as well as other embodiments of the present invention. As illustrated in FIG. 5, the case 500 may be equipped with a flap 510 to enclose the apparatus 100 into the case 500, a marking implement sheath 520 to secure the marking implement 120 and a carrying strap 530 to assist in carrying the apparatus 100.

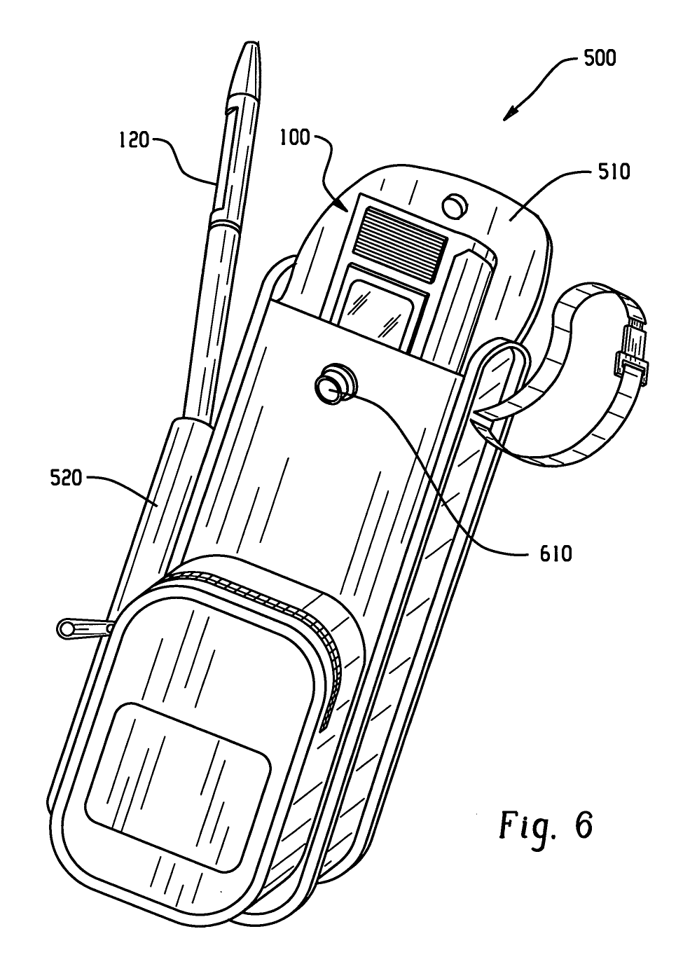

FIG. 6 illustrates a front perspective view of an open case 500 revealing the apparatus 100 contained therein. As illustrated in FIG. 6, the flap 510 is shown in the open position. As well, the marking implement 120 is shown partially withdrawn from the marking implement sheath 520. It will be appreciated that any flap fastening means 610 may be used in accordance with the present apparatus without departing from the spirit and/or scope described herein. For example, Velcro™, snaps or the like may be used in accordance with the present case 500.

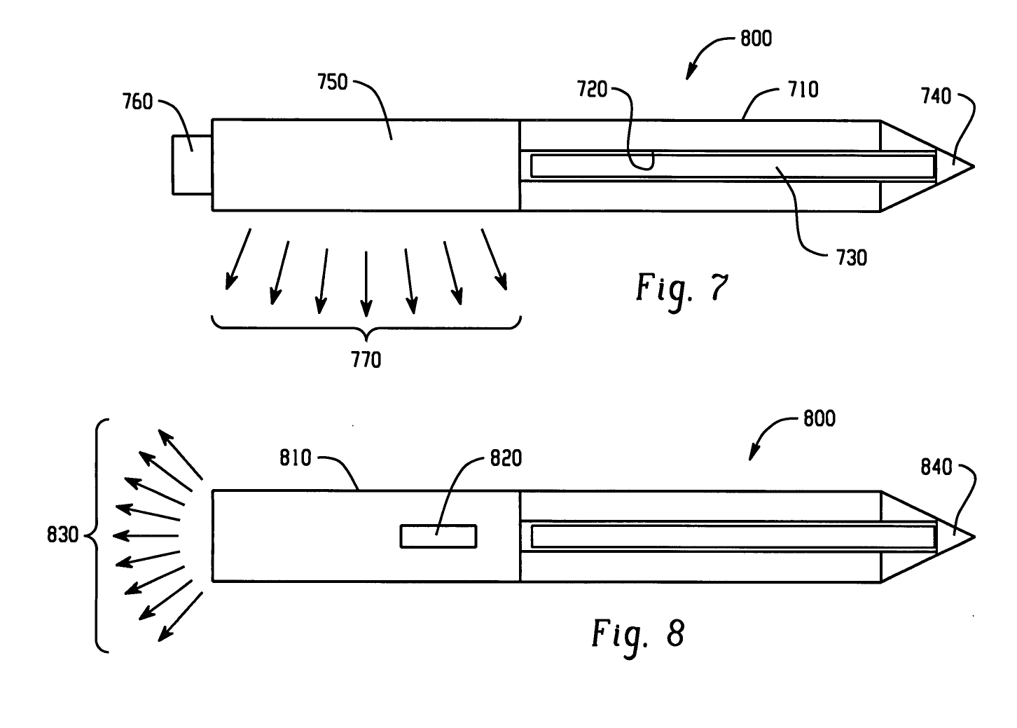

Now with reference to FIG. 7, a cross-sectional view of a combination marking implement and light assembly in accordance with an alternate disclosed embodiment is shown. Specifically, FIG. 7 illustrates a single marking apparatus 700 including a shaft 710 having a cavity 720 disposed throughout the length of the shaft 710. In other words, the shaft 710 may be configured as a hollow barrel whereas the hollow portion is the cavity 720. It will be appreciated that the marking implement of FIGS. 1-6 may be constructed in the same manner as the marking portion described with reference to FIG. 7 herein.

A well 730 to hold a quantity of a UV light-sensitive composite (e.g. “invisible ink”) may be suitably disposed within the cavity 720 whereby the UV light-sensitive composite may be transferred onto a substrate via a tip or opening 740. It will be appreciated that the well 730 to store a quantity of a UV light-sensitive composite (e.g. ink, wax) may be constructed in a replaceable refill fashion in accordance with other embodiments.

Continued reference to FIG. 7 illustrates a UV light source 750 in communication with the shaft 710. Additionally, a switching means 760 may be disposed opposite the opening 740 as illustrated. In operation, upon activating the switching means 760, the UV light source 750 illuminates providing UV light rays 770 as shown in FIG. 7. As previously discussed, the UV light rays 770 may be used in order to illuminate and reveal previously scribed invisible markings containing UV light-sensitive composites.

An alternate embodiment of a marking apparatus is illustrated in FIG. 8. The basic construction and operation of the apparatus 800 of FIG. 8 is the same as previously discussed with reference to FIG. 7 above. However, the apparatus 800 of FIG. 8 employs an alternate embodiment of a UV light source 810 and corresponding switching means 820.

Specifically, a UV light source 810 may be operated via a switching means 820. As shown in FIG. 8 and different from the apparatus 700 of FIG. 7, the direction of the UV light rays 830 of the alternate embodiment are directed opposite the tip or opening 840 of the apparatus 800.

It will be appreciated that the switching means 760 and 820 of FIG. 7 and FIG. 8 respectively may be any switching means known in the art. For example, switching means such as toggle, pressure sensitive switches or the like may be used without departing from the spirit and scope of the present apparatus.

While the present system has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the system, in its broader aspects, is not limited to the specific details, the representative apparatus, and illustrative examples shown and described. Accordingly, departures may be made from such details without departing from the spirit or scope of the applicant's general inventive concept.

Although the preferred embodiment has been described in detail, it should be understood that various changes, substitutions and alterations can be made therein without departing from the spirit and scope of the invention as defined by the appended claims.

1. A marking kit comprising:
a housing;
a marking implement to dispose an invisible mark onto a substrate; and
an ultraviolet light source disposed in communication with the housing to illuminate the invisible mark on the substrate.

2. The marking kit set forth in claim 1 wherein the invisible mark is an ultraviolet-sensitive ink mark.

3. The marking kit set forth in claim 1 wherein the marking implement includes:
a barrel;
a well to hold a quantity of an ultraviolet light-sensitive composite wherein the well is disposed within the barrel; and
an opening disposed on one end of the barrel to discharge the ultraviolet light-sensitive composite onto the substrate.

4. The marking kit set forth in claim 1 wherein the housing includes a cavity to store the marking implement.

5. The marking kit set forth in claim 1 wherein the housing includes a fastening means to secure the marking implement to the housing.

6. The marking kit set forth in claim 5 wherein the fastening means is Velcro™.

7. The marking kit set forth in claim 1 further including a power source to provide power to illuminate the ultraviolet light source.

8. The marking kit set forth in claim 7 wherein the power source is an alternating current (AC) power source.

9. The marking kit set forth in claim 7 wherein the power source is a direct current (DC) power source.

10. The marking kit set forth in claim 9 further including an AC/DC converter to convert an input power to the ultraviolet light source from AC to DC.

11. The marking kit set forth in claim 1 further comprising a handle to carry the housing.

12. The marking kit set forth in claim 11 wherein the handle is a strap.

13. The marking kit set forth in claim 1 further comprising a case to protect the housing.

14. The marking kit set forth in claim 1 wherein the substrate is a paper medium.

15. The marking kit set forth in claim 1 wherein the housing includes a cavity to secure the paper medium.

16. A marking apparatus to dispose an invisible mark onto a substrate comprising:
a shaft having a first end, a second end and a cavity therebetween;
a well to hold a quantity of an ultraviolet light-sensitive composite wherein the well is disposed within the cavity;
an opening disposed on the first end of the shaft to discharge the ultraviolet light-sensitive composite onto the substrate; and
an ultraviolet light source disposed in communication with the second end of the shaft to illuminate the invisible mark on the substrate.

17. The marking apparatus set forth in claim 16 further including a power source to provide power to illuminate the ultraviolet light source.

18. The marking apparatus set forth in claim 17 wherein the power source is a direct current (DC) power source.

19. The marking apparatus set forth in claim 17 wherein the power source is an alternating (AC) power source.

20. The marking apparatus set forth in claim 19 further including an AC/DC converter to convert an input power to the ultraviolet light source from AC to DC.
